(19) United States
(12) Patent Application Publication
(10) Pub. No.: US 2025/0091927 A1
(43) Pub. Date: Mar. 20, 2025

(54) DEVICES AND METHODS FOR PREVENTING A COOLING FLAT TUBE OF A PLATINUM CHANNEL FROM COLLAPSING DURING WARMING

(71) Applicant: CAIHONG DISPLAY DEVICES CO., LTD., Xianyang (CN)

(72) Inventors: Guohong YANG, Xianyang (CN); Menglong WANG, Xianyang (CN); Wei YANG, Xianyang (CN); Chao YU, Xianyang (CN)

(73) Assignee: CAIHONG DISPLAY DEVICES CO., LTD., Xianyang (CN)

(21) Appl. No.: 18/969,203

(22) Filed: Dec. 4, 2024

Related U.S. Application Data
(63) Continuation-in-part of application No. PCT/CN2024/092917, filed on May 13, 2024.

(30) Foreign Application Priority Data
Jun. 19, 2023 (CN) 202310730173.8

(51) Int. Cl. C03B 7/06; C03B 5/23

(52) U.S. Cl. CPC C03B 7/06; C03B 5/23

(57) ABSTRACT

Devices and methods for preventing a cooling flat tube of a platinum channel from collapsing during warming are provided. The devices include a traction structure. The cooling flat tube is externally wrapped with a plurality of heater modules. There may be a gap between the cooling flat tube and the plurality of heater modules. A docking seam is disposed between every two docked heater modules. The traction structure is disposed on an outer surface of the cooling flat tube and includes a traction hanging bar. A position of the traction hanging bar coincides with a position of the docking seam. By designing the special traction structure on the upper surface of the cooling flat tube, combined with a matching mounting manner, the stability of a cross section structure of the cooling flat tube during warming is realized, and the cooling flat tube is prevented from deforming and collapsing during warming.

### CROSS-REFERENCE TO RELATED APPLICATIONS

This application is a continuation-in-part of international Application No. PCT/CN2024/092917, filed on May 13, 2024, which claims priority to Chinese Patent Application No. 202310730173.8, filed on Jun. 19, 2023, the entire contents of each of which are incorporated herein by reference.

### TECHNICAL FIELD

The present disclosure relates to the technical field of substrate glass manufacturing, and in particular, to devices and methods for preventing a cooling flat tube of a platinum channel from collapsing during warming.

### BACKGROUND

A platinum channel is one of the core devices in the process of substrate glass manufacturing. A cooling section is the most difficult and risky part of the platinum channel during manufacturing and warming, which is mainly determined by a special structural form of the cooling section. The main function of the cooling section in the platinum channel is to carry out rapid and uniform heat dissipation and cooling of glass melt after stirring and homogenization, so that a temperature of the glass melt can be lowered from 1,400° C. at an inlet end to about 1,220° C. at an outlet end, i.e., a temperature of the glass melt required for a subsequent molding process is met. Due to the limited space layout of the platinum channel, and the extremely expensive manufacturing cost, it is necessary to realize as uniform as possible heat dissipation in a shortest path, and a structure of a flat tube can basically satisfy the demand.

Compared with a traditional round tube, the glass melt in a central region of a cross section of the flat tube is closer to a surface of the flat tube, which makes the heat dissipation efficiency several times higher than that of the traditional round tube. Combined with refractory structures of the different parts of the periphery and different thermal conductivities of the refractory structures, the requirement of efficient and uniform heat dissipation can be met. Since the flat tube is made of platinum material and a wall thickness is generally designed to be in a range of 1.0 mm-1.5 mm, and a certain proportion of rhodium (Rh) may be added to the material to realize the strength and reliability of the structure. However, since the proportion of rhodium is constrained by cost, ductility, and inflation management, only a certain degree of reinforcement of the flat tube can be realized, and a complete guarantee of strength cannot be achieved.

There is a dedicated warming phase in the substrate glass manufacturing process. The platinum and refractory material can be gradually adapted to a high temperature of the environment mainly through a certain curve of the warming rate. During the period, the delivery amount of glass raw material in front-end of the platinum channel may be synchronously increased, and a liquid surface height of the internal molten glass of the platinum channel may be gradually improved, so that the platinum channel is full of glass melt finally. However, in the process of rising from room temperature to 1300° C., the cooling section cannot be filled with the glass melt completely since the cooling section is at the back of the platinum channel. Therefore, during warming, the stability of the flat tube structure of the cooling section cannot be fully guaranteed in an empty tube state since the flat tube structure solely relies on the structural strength of the flat tube without the inability to be supported by the internal glass melt. The upper surface of the flat tube often collapses and deforms during warming. At present, the display abnormality of the thermocouples welded to the upper surface of the cooling flat tube is mainly used to determine that the thermocouple wires are subjected to a tensile force and the failure is caused. The greater the count of failed thermocouples is, the smaller the structural strength of the cooling flat tube is. Therefore, the deformation of the cooling flat tube is always one of the main problems during warming. In the prior art, many improvements were performed in the process, which include increasing a count of welding seams to improve structural stability and the process improvement to prevent the initial collapse in the manufacturing process, etc. The deformation of the cooling flat tube is not completely solved.

Therefore, it is desirable to provide devices and methods for preventing a cooling flat tube of a platinum channel from collapsing during warming, so as to realize that the cooling flat tube is efficiently prevented from deforming and collapsing during warming.

### SUMMARY

One or more embodiments of the present disclosure provide devices and methods for preventing a cooling flat tube of a platinum channel from collapsing during warm to overcome the problem that the cooling flat tube fails to be prevented from deforming and collapsing during warming. The problem of deformation and collapse may be solved through structural assistance with a clear point of action and a direct effect, which has a relatively good positive effect on inhibiting the collapse of the cooling flat tube during warming.

To this end, one or more embodiments of the present disclosure provide a device for preventing a cooling flat tube of a platinum channel from collapsing during warming. The device may include a traction structure. A cooling flat tube may be externally wrapped with a plurality of heater modules. There may be a gap between the cooling flat tube and the plurality of heater modules. A docking seam may be disposed between every two docked heater modules. The traction structure may be disposed on an outer surface of the cooling flat tube. The traction structure may include a traction hanging bar. A position of the traction hanging bar may coincide with a position of the docking seam. A protruding end of the traction hanging bar may extend out of the docking seam. The protruding end may be connected to an end of one of the two docked heater modules, and a height of the traction hanging bar may be equal to a height of the gap between the cooling flat tube and the plurality of heater modules.

One or more embodiments of the present disclosure provide a method of preventing a cooling flat tube of a platinum channel from collapsing during warming. The method is implemented by the device in the embodiments of the present disclosure. The method may include assembling the plurality of heater modules and filling the cooling flat tube with powder. In the filling process, the cooling flat tube may be vibrated, and the vibration of the cooling flat tube may be stopped when the filling is finished. The method may further include starting to heat the platinum channel, and after the platinum channel warms up to a preset temperature, performing a secondary filling on the docking seam where the traction hanging bar protrudes.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating a connection of a traction structure disposed in a direction of a cross section of a cooling flat tube according to some embodiments of the present disclosure;

FIG. 2 is a schematic diagram illustrating an overall structure of a cooling section according to some embodiments of the present disclosure;

FIG. 3 is a detail view of a traction hanging bar disposed on an upper surface of a cooling flat tube according to some embodiments of the present disclosure;

FIG. 4 is a schematic diagram illustrating a traction principle at a top of a cooling flat tube according to some embodiments of the present disclosure;

FIG. 5 is a schematic diagram illustrating overall traction of a cooling section according to some embodiments of the present disclosure;

FIG. 6(a) is a schematic diagram illustrating an exemplary initial traction hook and an exemplary reinforcing hook according to some embodiments of the present disclosure;

FIG. 6(b) is a left view of an initial traction hook according to some embodiments of the present disclosure;

FIG. 7 is a flowchart illustrating an exemplary process for preventing a cooling flat tube of a platinum channel from collapsing during warming according to some embodiments of the present disclosure;

FIG. 8 is a schematic diagram illustrating an exemplary inflation prediction model according to some embodiments of the present disclosure; and

FIG. 9 is a schematic diagram illustrating an exemplary sealing degree model according to some embodiments of the present disclosure.

In the figures, 1, cooling flat tube; 2, traction substrate; 3, traction hanging bar; 3-1, welding bottom; 3-2, extension arm; 3-3, traction hook; 4, heater modules; 4-1, transverse through groove structure; 5, filler layer; 610, initial traction hook; 620, reinforcing hook; 630, gap between the reinforcing hook and the Initial traction hook; 640, gap between the traction hook and the transverse through groove structure.

### DETAILED DESCRIPTION

In order to enable those skilled in the art to better understand the embodiments of the present disclosure, the technical solutions relating to the embodiments of the present disclosure are clearly and completely illustrated below in conjunction with the drawings in the embodiments of the present disclosure. Obviously, the embodiments described below are only some embodiments instead of all the embodiments of the present disclosure. Based on the embodiments of the present disclosure, all other embodiments obtained by those skilled in the art without making creative effects shall fall within the scope of protection of the present disclosure.

It should be noted that the terms “first,” “second,” etc. in the specification and claims of the present disclosure and the drawings described above are used to distinguish similar objects and need not be used to describe a particular order or sequence. “It should be understood that the data used may be interchangeable when appropriate, so that the embodiments of the present disclosure described herein can be practiced in an order other than those illustrated or described herein. In addition, the terms “comprise,” “comprises,” and/or “comprising,” “include,” “includes,” and/or “including,” and any variations thereof are intended to cover non-exclusive inclusion, e.g., a process, method, system, product, or device that includes a series of steps or units need not be limited to those that are clearly listed, but may include other steps or units that are not clearly listed or are inherent to the process, method, product, or device.

When describing the operations performed in the embodiments of the present disclosure in terms of steps, the order of the steps is interchangeable if not otherwise specified, the steps can be omitted, and other steps may be included in the operation.

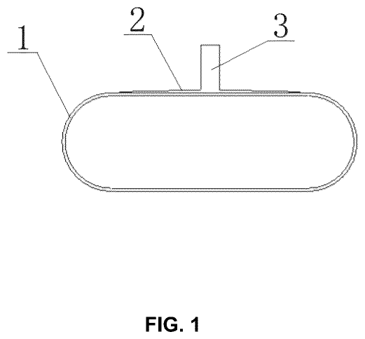

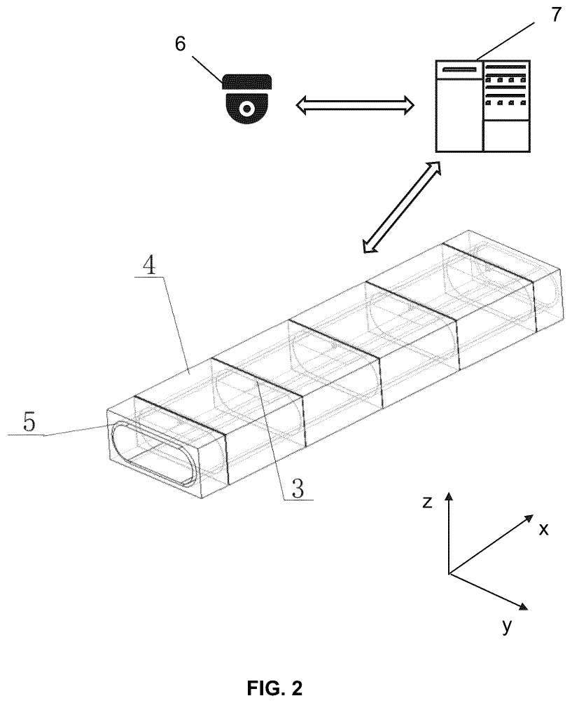

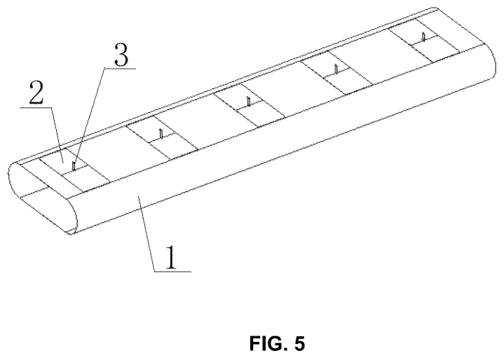

FIG. 1 is a schematic diagram illustrating a connection of a traction structure disposed in a direction of a cross section of a cooling flat tube according to some embodiments of the present disclosure. FIG. 2 is a schematic diagram illustrating an overall structure of a cooling section according to some embodiments of the present disclosure. FIG. 5 is a schematic diagram illustrating overall traction of a cooling section according to some embodiments of the present disclosure.

In some embodiments, as shown in FIG. 1, FIG. 2, and FIG. 5, a device for preventing a cooling flat tube of a platinum channel from collapsing during warming may include a traction structure. A cooling flat tube 1 may be externally wrapped with a plurality of heater modules 4. There may be a gap between the cooling flat tube and the plurality of heater modules. A docking seam may be disposed between every two docked heater modules 4.

As shown in FIG. 2, a rectangular coordinate system is established to indicate spatial directions. The x-axis is a direction of flow of glass melt. The y-axis is a direction perpendicular to the direction of flow of glass melt. The z-axis is a direction perpendicular to the direction of flow of glass melt. For the convenience of illustration, the direction is illustrated through axial directions of the rectangular coordinate system as follows.

The cooling flat tube refers to a portion of a platinum channel. The cooling flat tube may be configured to dissipate heat to cool the glass melt in the platinum channel. The traction structure refers to a structure that tracts the cooling flat tube. The traction structure may prevent the cooling flat tube from collapsing during warming by tracting the cooling flat tube. The plurality of heater modules may wrap around the cooling flat tube without coming into direct contact with the cooling flat tube. There may be a gap between the cooling flat tube and the plurality of heater modules.

The traction structure may be disposed on an outer surface of the cooling flat tube 1. The traction structure may include a traction hanging bar 3. A position of the traction hanging bar 3 may coincide with a position of the docking seam. A protruding end of the traction hanging bar 3 may extend out of the docking seam. The protruding end may be connected to an end of one of the two docked heater modules 4. A height of the traction hanging bar 3 may be equal to a height of the gap between the cooling flat tube 1 and the plurality of heater modules 4.

The stability of a cross-sectional structure of the cooling flat tube during warming may be achieved by designing a special traction structure on an upper surface of the cooling flat tube. The collapse problem may be solved by means of structural assistance, which has a clear application point and a direction effect, thereby preventing the cooling flat tube from deforming and collapsing during warming.

The end of one of the two docked heater modules refers to an end of an upper surface of the heater module that is close to the docking seam. A size of the gap refers to a width in the z-axis direction of a gap between the upper surface of the cooling flat tube and a lower surface of the plurality of heater modules.

In some embodiments, as shown in FIG. 1 and FIG. 5, the traction structure may further include a traction substrate 2. The traction substrate 2 may be connected to an upper surface of the cooling flat tube 1. The traction substrate may be configured to exert a force in the y-axis direction on the cooling flat tube.

In some embodiments, the traction substrate 2 may adopt a variable wall thickness structure. The variable wall thickness structure refers to a structure in which a wall thickness changes with a change in direction. The variable wall thickness structure may include any feasible structure in which a wall thickness of the traction substrate 2 changes from small to large and then from large to small in a radial direction (y-axis direction) of the cooling flat tube 1. The wall thickness of the traction substrate refers to a wall thickness of the traction substrate in the z-axis direction.

In some embodiments, a material of the traction substrate 2 may include a metal, an alloy, etc. For example, the traction substrate may be a platinum sheet of any feasible shape (e.g., a rectangle, etc.). The traction substrate 2 may be connected to the upper surface of the cooling flat tube 1 through a fixed connection mode, etc., for example, the connection mode may include a hot forging patch, etc.

In some embodiments, taking a rectangular platinum sheet with an original thickness of 1.5 mm and a cooling flat tube 1 with a thickness of 1.0 mm as an example, the process of hot forging patch may include laminating the rectangular platinum sheet with an original thickness of 1.5 mm and the upper surface of the cooling flat tube 1 with a thickness of 1.0 mm, and adopting high-temperature forging to generate a certain adhesive force between an edge of the rectangular platinum sheet and the cooling flat tube 1. At the same time, for a middle region of the rectangular platinum sheet with a relatively large thickness, the welding of the rectangular platinum sheet and the cooling flat tube 1 may be completed by adding a small amount of welding wire on both sides of the rectangular platinum sheet along the radial direction of the cooling flat tube 1.

In some embodiments, a dimension of the traction substrate 2 may be related to a dimension of the upper surface of the cooling flat tube. For example, if the width (width in the y-axis direction) of the upper surface of the cooling flat tube 1 is in a range of 600 mm-700 mm, or 620 mm-680 mm, etc., a width of the traction substrate 2 in the radial direction of the cooling flat tube 1 may be in a range of 100 mm, or 110 mm, etc., and a width of the traction substrate 2 in the direction (x-axis direction) of flow of glass melt may be in a range of 50 mm-80 mm, or 60 mm-90 mm, etc.

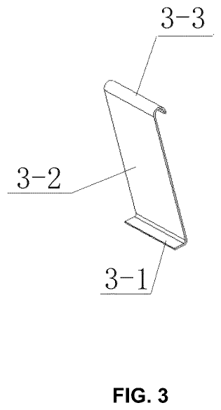

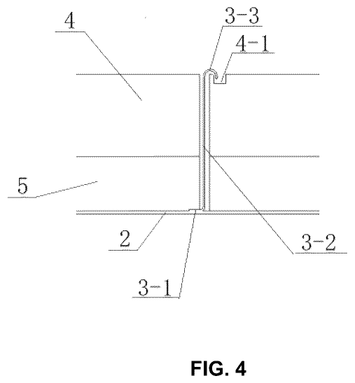

FIG. 3 is a detail view of a traction hanging bar disposed on an upper surface of a cooling flat tube according to some embodiments of the present disclosure. FIG. 4 is a schematic diagram illustrating a traction principle at a top of a cooling flat tube according to some embodiments of the present disclosure.

In some embodiments, as shown in FIG. 3 and FIG. 4, the traction hanging bar 3 may include a welding bottom 3-1, an extension arm 3-2, and a traction hook 3-3. The welding bottom may be configured to be fixedly connected to the traction substrate. The extension arm may be configured to extend out of the docking seam. The traction hook may be configured to be connected to an end of one of the two docked heater modules.

The welding bottom 3-1 may be fixedly connected to the traction substrate 2 by welding, etc. The welding may include complete welding, etc. The extension arm 3-2 may be disposed in the docking seam. An upper surface of the end of the one of the two docked heater modules 4 may be provided with a transverse through groove structure 4-1, and the traction hook 3-3 may be suspended in the transverse through groove structure 4-1. The transverse through groove structure refers to a through groove structure disposed along the y-axis direction.

As shown in FIG. 3, the traction hook 3-3 may be suspended in the transverse through groove structure 4-1 to realize that the traction hanging bar is connected to the end of the one of the two docked heater modules.

In some embodiments, a dimension of the extension arm 3-2 may be set in advance, and a width of the docking seam (width in the x-axis direction) and a wall thickness of the extension arm 3-2 (a thickness in the x-axis direction) may satisfy a preset correspondence. A depth of the transverse through groove structure 4-1 (depth in the z-axis direction) may be in a preset depth range. The preset correspondence may include that the width of the docking seam is greater than 20% or 25% of a wall thickness of the extension arm, etc. The preset depth range may include 5 mm-10 mm, or 6 mm-9 mm, etc.

In some embodiments, a length (length in the z-axis direction) of the extension arm 3-2 may be in a range of 70 mm-90 mm. The width (width in the y-axis direction) of the extension arm 3-2 may be greater than 15 mm, and the wall thickness (thickness in the x-axis direction) of the extension arm 3-2 may be greater than 1.0 mm.

In some embodiments, the traction hook 3-3 may be in a plurality of shapes. For example, the traction hook 3-3 may include a hook in any feasible shape (e.g., a circular hook, a claw hook, etc.). The shape of the traction hook 3-3 may be configured to be matched with the transverse through groove structure 4-1 to realize that the traction hook 3-3 is suspended in the transverse through groove structure 4-1.

In some embodiments, a width (width in the y-axis direction) of the transverse through groove structure 4-1 may be set in advance, for example, 5 mm, or 7 mm, etc.

In some embodiments of the present disclosure, the traction hanging bar may be designed to be suspended in the transverse through groove structure, which realizes the traction and transmission of the traction hanging bar from the internal cooling flat tube to the external heater modules. Only a width between the two front and rear heater modules may need to be reserved so that the width between the front and rear two heater modules and the wall thickness of the extension arm meets the preset correspondence, which effectively solves the problem of internal and external traction and transmission and the basic sealing problem of the structure.

In some embodiments, a radial (y-axis direction) dimension distribution of the traction hanging bar 3 may be the same as a radial (y-axis direction) dimension distribution of a cross section of the cooling flat tube 1. The same radial dimension distribution means that the cross section of the traction hanging bar and the cooling flat tube are parallel in space.

In some embodiments, a material of the traction hanging bar 3 may be an alloy material, for example, a platinum-rhodium alloy material. A rhodium content of the platinum-rhodium alloy material may be in a preset content range. The preset content range may include 10%-20%, or 12%-18%, etc. The rhodium content refers to a mass of rhodium metal as a percentage of a total mass of the alloy.

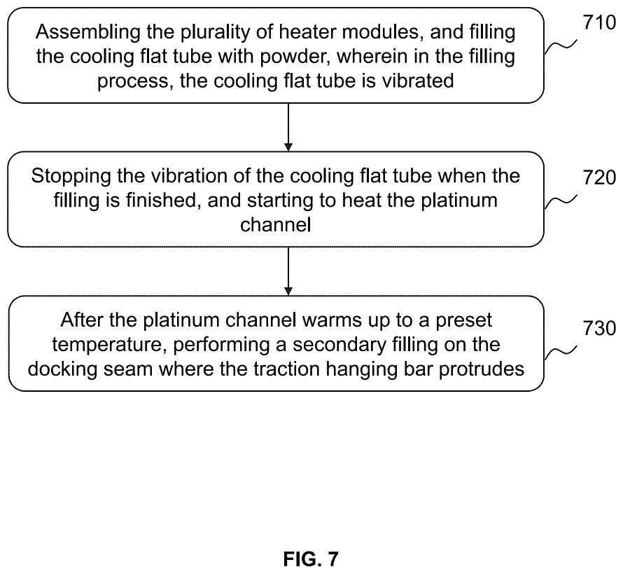

In some embodiments, a filler layer 5 may be disposed between the cooling flat tube 1 and the heater modules 4. The filler layer may be configured to fill the gap between the cooling flat tube 1 and the plurality of heater modules 4. More descriptions regarding the filler layer may be found in FIG. 7 and the descriptions thereof.

In some embodiments, a count of traction structures may be set in advance based on a count of docking seams between the plurality of heater modules. For example, the greater the count of docking seams is, the greater the count of traction structures may be.

In some embodiments, the device for preventing the cooling flat tube of the platinum channel from collapsing during warming may further include a reinforcing hook 620. The traction hanging bar may include an initial traction hook 610.

The reinforcing hook refers to a hook that assists the traction hanging bar in tracting the cooling flat tube. In some embodiments, the reinforcing hook may be fixedly connected to other devices of a platinum channel or ground to ensure that the reinforcing hook is in a fixed state and is not subject to expansion or collapse deformation. The other devices may include any feasible device of the platinum channel that is in the fixed state.

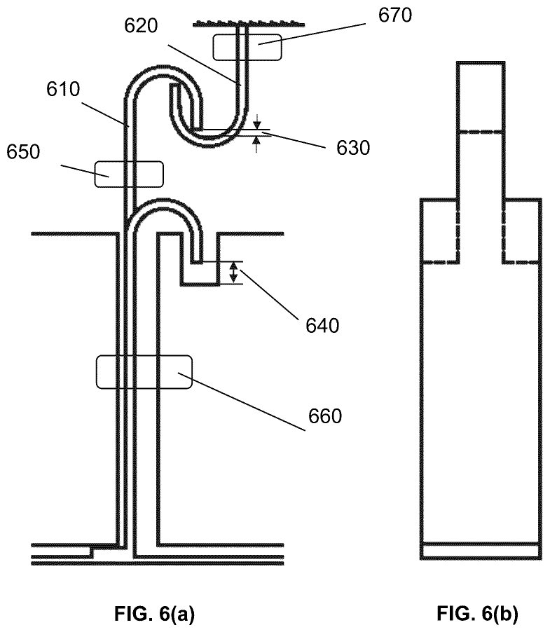

In some embodiments, the reinforcing hook may be provided with a driving device corresponding to the reinforcing hook. The driving device refers to a device that drives the reinforcing hook to move in a vertical or horizontal direction. For example, the driving device may include a motor, a cylinder, or the like, or any combination thereof. As shown in FIG. 6(a), the driving device may be disposed at a position 670.

In some embodiments, the driving device may pull the reinforcing hook to move based on a target parameter. More descriptions may be found in FIG. 7 and the related descriptions thereof.

The initial traction hook refers to a hook of the traction hanging bar that assists the traction hanging bar in tracting the cooling flat tube. In some embodiments, the initial traction hook may be disposed at a middle position of the traction hanging bar 3, and two sides of the initial traction hook may be provided with traction hooks 3-3.

In some embodiments, in conjunction with FIG. 6(a) and FIG. 6(b), the reinforcing hook 620 may be matched with the initial traction hook 610, and a gap 630 between the reinforcing hook 620 and the initial traction hook 610 may be smaller than a gap 640 between the traction hook and the transverse through groove structure, so that the reinforcing hook 620 may assist the traction hanging bar in tracting the cooling flat tube. It is understood that when the deformation of the cooling flat tube is relatively small, and since the gap between the reinforcing hook and the initial traction hook is smaller, the initial traction hook may make contact with the reinforcing hook first, and the reinforcing hook may tract the traction hanging bar.

In some embodiments of the present disclosure, the reinforcing hook and the initial traction hook may assist the traction hanging bar in tracting the cooling flat tube, which reduces the load of the traction hanging bar and improves the safety of the traction hanging bar.

In some embodiments, the device for preventing the cooling flat tube of the platinum channel from collapsing during warming may further include a plurality of displacement sensors.

In some embodiments, the plurality of displacement sensors may be configured to measure displacement information of the initial traction hook and/or inflation information of the plurality of heater modules. In conjunction with FIG. 6(a) and FIG. 6(b), the plurality of displacement sensors may be disposed at a position 650 and/or a position 660. More descriptions regarding the displacement information and the inflation information may be found in FIG. 7 and the related descriptions thereof.

In some embodiments, the plurality of displacement sensors may include a distance sensor. For example, the plurality of displacement sensors may include a grating sensor, a linear displacement sensor, or the like, or any combination thereof.

In some embodiments of the present disclosure, by providing the plurality of displacement sensors, the displacement of the initial traction hook and the expansion of the heater module may be effectively obtained, thereby determining the target parameter of the driving device. More descriptions regarding the determining the target parameter of the driving device may be found in FIG. 7 and the related descriptions thereof.

In some embodiments, as shown in FIG. 2, the device for preventing the cooling flat tube of the platinum channel from collapsing during warming may further include an image obtaining device 6. The image obtaining device is configured to obtain an image of the docking seam. For example, the image obtaining device may include a camera with a rotatable angle, etc.

The image of the docking seam refers to an image obtained by taking a filling process of the docking seam from a plurality of angles. The plurality of angles for taking the filling process of the docking seam may be set in advance based on historical experience.

In some embodiments of the present disclosure, by providing the image obtaining device, the image of the filling process of the docking seam may be obtained in time, which facilitates determining whether to stop filling. More descriptions regarding the determining whether to stop filling may be found in FIG. 7 and the related descriptions thereof.

In some embodiments, as shown in FIG. 2, the device for preventing the cooling flat tube of the platinum channel from collapsing during warming may further include a processor 7.

The processor may be configured to process data related to the device for preventing the cooling flat tube of the platinum channel from collapsing during warming. In some embodiments, the processor may include a central processing unit, an application-specific integrated circuit, an image processing unit, or the like, or any combination thereof. The processor may be communicatively connected to the image obtaining device, the driving device, and the plurality of displacement sensors. The processor may be disposed at a control center of a production line for substrate glass manufacturing.

In some embodiments, the processor may be integrated with a storage. The storage may be configured to store the data related to the device for preventing the cooling flat tube of the platinum channel from collapsing during warming.

In some embodiments of the present disclosure, the processor may process the data related to the device for preventing the cooling flat tube of the platinum channel from collapsing during warming, which reduces a count of times of manual interventions and reduces the likelihood of risk.

FIG. 7 is a flowchart of an exemplary process for preventing a cooling flat tube of a platinum channel from collapsing during warming according to some embodiments of the present disclosure.

In some embodiments, the process for preventing a cooling flat tube of a platinum channel from collapsing during warming may be implemented by a device for preventing a cooling flat tube of a platinum channel from collapsing during warming. The process may include the following operations.

In 710, the plurality of heater modules may be assembled, and the cooling flat tube may be filled with powder. In the filling process, the cooling flat tube may be vibrated.

In some embodiments, when the plurality of heater modules 4 are assembled, the cooling flat tube 1 may be filled once. The filling once refers to filling of a gap between the cooling flat tube and the plurality of heater modules.

In some embodiments, a long material chute may be configured to fill the powder in four directions (in upper, lower, left, and right directions) of the cooling flat tube 1, respectively. A vibrator may be used to vibrate the cooling flat tube 1 during the filling. An amplitude of the vibration applied to the cooling flat tube by the vibrator may be set in advance based on historical experience. For example, the amplitude of the vibration may be smaller than 2 mm.

In some embodiments, the filling may be any feasible powder, for example, an alumina fine powder of a particle size of 0.1 mm.

In some embodiments of the present disclosure, the conventional alumina fine slurry may be changed to a powder of alumina, and a segmented stepwise filling manner may be used to solve the problem of good flowability that cannot be achieved by the powder.

In 720, the vibration of the cooling flat tube may be stopped when the filling is finished, and the platinum channel may start to be heated.

In 730, after the platinum channel warms up to a preset temperature, a secondary filling may be performed on the docking seam where the traction hanging bar protrudes.

In some embodiments, after the platinum channel warms up to the preset temperature, the secondary filling may be performed on the docking seam where the traction hanging bar 3 protrudes. The preset temperature may be set in advance based on actual need, for example, the preset temperature may be 1300° C., 1200° C., etc.

In some embodiments, for the device for preventing the cooling flat tube of the platinum channel from collapsing during warming, the traction structure may be connected to the cooling flat tube 1 in the form shown in FIG. 1. In a direction of a cross section of the cooling flat tube 1, the cooling flat tube 1, the traction substrate 2 and the traction hanging bar 3 may be included.

In some embodiments, a feature of an overall structure of a cooling section may be taken into account, i.e., heater bricks (also referred to as heater modules) may be disposed outside of the cooling flat tube 1. In some embodiments, as shown in FIG. 2, the heater modules 4 disposed outside the cooling flat tube 1 may be connected in groups.

Since the heater modules 4 need to maintain structural integrity, i.e., heating wires inside the heater modules 4 need to be uniformly and equidistantly distributed, punching holes in the middle of the heater modules 4 would damage the integrity of the layout of the heating wires. Therefore, the traction hanging bar 3 can not protrude through the holes punched in an upper surface and a lower surface of an upper heater module 4.

In some embodiments, the traction hanging bar 3 may adopt the same radial distribution as the cross section of the cooling flat tube 1 and may protrude from the docking seam between the two heater modules 4 and be suspended in an end region of one of the two heater modules 4, which solves the problem that the traction hanging bar 3 cannot protrude from the heater modules 4, and further solves the problem of shear force on the traction hanging bar due to relative displacement between the inflation in the direction of the flow of the glass melt and the refractory.

Because a traction force point of the traction hanging bar 3 is relatively small, the local traction cracking problem may be very easy to occur in the stressing force-bearing process, so the traction hanging bar 3 may not be directly welded to the cooling flat tube 1. In some embodiments, the traction substrate 2 may be disposed between the traction hanging bar 3 and the cooling flat tube 1, thereby effectively avoiding the local traction cracking of the traction hanging bar 3 in the force-bearing process.

In some embodiments, as shown in FIG. 1, in the direction of the cross section, the traction substrate 2 may be thin on two sides and thick in the middle, thereby effectively eliminating the problem of stress concentration problem that may be brought by the local dimension abrupt change caused by transition of thickness of the two sides.

In some other embodiments, the traction substrate 2 may be connected to the cooling flat tube 1 through a hot forging patch, i.e., a rectangular platinum sheet with an original thickness of 1.5 mm may be laminated to the upper surface of the cooling flat tube 1 with a thickness of 1.0 mm, and high-temperature forging may be adopted to generate a certain adhesive force between an edge of the rectangular platinum sheet and the cooling flat tube 1. At the same time, for the middle region of the rectangular platinum sheet with a relatively large thickness, welding may be performed by adding a small amount of welding wires on both sides of the rectangular platinum sheet in the radial direction of the cooling flat tube 1 to ensure the overall bonding between the traction substrate 2 and the upper surface of the cooling flat tube 1.

To ensure the traction effect of the traction substrate 2 on the upper surface of the cooling flat tube, in some embodiments, rectangular traction substrates 2 of different dimensions may be selected for upper surfaces of the cooling flat tube of different areas. Taking the cooling flat tube 1 with a width of 600 mm to 700 mm as an example, a width of the traction substrate 2 may be 100 mm, and a width of the traction substrate 2 in a direction of flow of the glass melt may be in a range of 50 mm-80 mm.

In some embodiments of the present disclosure, by designing the traction substrate, the problem of the traction structure being highly susceptible to local traction cracking in the stressing process due to the relatively small traction force point of the traction structure may be avoided.

In some embodiments, as shown in FIG. 3, the traction hanging bar 3 may include the welding bottom 3-1, the extension arm 3-2, and the traction hook 3-3. The welding bottom 3-1 of the traction structure may be connected to the lower traction substrate 2 in a form of complete welding.

As shown in FIG. 4, a length of the extension arm 3-2 may be related to a thickness of the internal filler layer 5 and the external heater modules 4. For example, if a standard filling thickness of the filler layer is 15 mm, and a thickness of the heater modules 4 is in a range of 50 mm-70 mm, the length of the extension arm may be in a range of 65 mm-85 mm. The standard filling thickness refers to a filling thickness that ensures a structural strength of a refractory material.

The width and thickness of the extension arms 3-2 may determine a load-bearing capacity of the traction structure, and the load-bearing capacity of the traction structure may be also related to a material of the traction hanging bar 3 as a whole. In some embodiments, the material of the traction hanging bar 3 as a whole may be the same as or different from a material of the cooling flat tube 1. For example, if the cooling flat tube 1 is made of a platinum-rhodium alloy with a rhodium content in a range of 5% to 10%, the traction hanging bar 3 may be made of a platinum-rhodium alloy with a rhodium content in a range of 10% to 20%. The larger the rhodium content of the platinum-rhodium alloy is, the greater the tensile strength of the material may be.

If the traction hanging bar 3 is made of a platinum-rhodium alloy with a rhodium content in the range of 10% to 20%, the width of the extension arm 3-2 being greater than 15 mm and a wall thickness being greater than 1.0 mm may be sufficient to satisfy the load-bearing capacity requirement of the traction structure. The load-bearing capacity requirement may be obtained by a technician through many experiments.

In some embodiments, the traction hook 3-3 may include a circular hook or a hook in other shapes. A shape of the traction hook 3-3 may be configured to be matched with the transverse through groove structure 4-1, so that the traction hook 3-3 may be suspended in the transverse through groove structure 4-1.

In some embodiments, as shown in FIG. 4, the transverse through groove structure 4-1 may be disposed at an upper surface of a docking point of the external heater modules 4. The transverse through groove structure 4-1 may be configured for the suspension of the traction hanging bar 3, which realizes the traction transmission of the traction hanging bar 3 from the internal cooling flat tube 1 to the external heater modules 4. The transverse through groove structure 4-1 may be set in advance based on actual needs. For example, a width of the transverse through groove structure 4-1 may be 5 mm, a depth of the transverse through groove structure 4-1 may be in a range of 5 mm to 10 mm, etc.

In some embodiments, only a width between the front and rear heater modules 4 that is greater than 20% of the wall thickness of the extension arm 3-2 may need to be reserved, which ensures basic sealing problem in the cooling section.

In some embodiments, a count of traction structures may be set in advance based on a count of docking seams between the plurality of heater modules. For example, the greater the count of docking seams is, the greater the count of traction structures may be.

In some embodiments of the present disclosure, one end of the traction structure may be welded to the cooling flat tube through the traction substrate, and the other end may be suspended in the transverse through groove structure of the heater modules, so that the reaction force of collapsing of the cooling flat tube may be transmitted to the upper heater modules, thereby ensuring that the structure of the flat tube is not deformed. For the installation process matched with the structure, the original fine slurry filling material may be adjusted to the powder with a sintering temperature at a preset temperature, which avoids the traction structure from being subject to the shear force in the direction of the flow of the glass melt in the warming and inflation process. At the same time, after the inflation ends, the secondary filling of the powder may be performed on the docking seam between the heater modules, which ensures the basic sealing.

In some embodiments, in the process for preventing the cooling flat tube of the platinum channel from collapsing during warming, the traction structure of the upper surface of the cooling flat tube 1 of the device for preventing the cooling flat tube of the platinum channel from collapsing during warming and the installation process matched with the structure may realize the structural reinforcement of the cooling flat tube 1.

The force during warming may need to be considered for the traction structure. A traditional filler layer between the cooling flat tube and the heater modules may be filled with alumina fine slurry. The alumina fine slurry at 700° C. of the warming stage may have a certain strength. At this time, the inflation of platinum may not be finished, and there may be a difference between an inflation coefficient of the cooling flat tube and an inflation coefficient of the external heater modules, which results in a relative displacement of the cooling flat tube and the external heater modules and even leads to a shear stress force between the hanging bar and the cooling flat tube 1, thereby leading to a local tear.

In some embodiments of the present disclosure, the direction of the traction hanging bar 3 may be structurally designed to be the same radial distribution as the cross section of the cooling flat tube 1, which withstands a certain amount of relative displacement and does not cause a relatively obvious shear stress force on the root of the traction hanging bar 3. To ensure the complete force-free, the alumina fine slurry is changed to the alumina powder. The manner of gradual filling in segments may be adopted to solve the problem of good fluidity that cannot be achieved by the powder, i.e., the heating modules are assembled, the powder is filled in four directions (in the upper, lower, left, and right directions) of the flat tube using the long material chute, respectively, and at the same time, the vibrator is used to vibrate the cooling flat tube 1 in the filling process, so as to make the powder fully and evenly filled. The vibration of the cooling flat tube is stopped when the filling is finished. The platinum channel may start to be heated. In the actual warming process, the powder may be in an unbonded state, which basically does not affect the free movement of the internal platinum and the hanging bar structure. When the platinum channel warms up to the preset temperature, the inflation of the platinum structure may basically end, and the filling material may be sintered at this time, so that the cooling flat tube 1, the filler layer 5, and the heater modules 4 may form a whole. The secondary filling is performed on the docking seam of which the traction hanging bar 3 extends out, which ensures the final sealing of the whole structure.

The design of the present disclosure can cope with an increasing platinum dimension, and provide an effective guarantee of structural reliability for the design of a platinum channel structure with a larger elicitation amount, and a count of thermocouple failures at the cooling top of the warming process is significantly reduced, which indicates that the structural strength of the cooling flat tube is significantly improved.

In some embodiments, the processor may determine a plurality of triggering time points in the process of the platinum channel warming up to the preset temperature. At each of the plurality of triggering time points, the process may determine, based on displacement information of an initial traction hook and inflation information of a heater module connected to the traction structure, a target parameter of the driving device to cause the driving device to pull a reinforcing hook to move based on the target parameter. More descriptions regarding the initial traction hook and the driving device may be found in FIG. 6.

The triggering time point refers to a time point configured to determine the target parameter. The target parameter refers to a parameter related to operation of the driving device. In some embodiments, the target parameter of the driving device may include a distance, a direction, etc., that the reinforcing hook is driven.

In some embodiments, there may be the plurality of triggering time points in the process of the platinum channel warming up to the preset temperature. The processor may determine a first triggering time point as the initial time point, and a triggering time point subsequent to the initial time point as a subsequent time point.

In some embodiments, the processor may determine the plurality of triggering time points in various ways. For example, the processor may set the plurality of triggering time points in advance during warming with a same time interval between each time point.

In some embodiments, the processor may determine the initial time point based on an initial warming rate, an initial delivery rate of the glass raw material, and a target elicitation amount of glass melt. At the initial time point and at each subsequent time point, the processor may determine a next triggering interval based on a current warming rate, a current delivery rate, and the target elicitation amount and determine a next time point based on a current time point and the next triggering interval.

The target elicitation amount of the glass melt refers to an amount or mass, etc., of the glass melt that is elicited through the cooling flat tube. In some embodiments, the target elicitation amount may be set in advance based on a production requirement.

The warming rate refers to a rate at which a temperature of the glass melt in a glass furnace increases. In some embodiments, the processor obtains a warming rate at which the glass melt in the glass furnace begins to warm as the initial warming rate through a warming curve. The glass furnace refers to a device that heats and melts glass raw material to obtain the glass melt.

The warming curve reflects a change in the temperature of the glass melt in the glass furnace as time increases. The warming rate may be expressed by a ratio of a temperature value to a time coordinate of the warming curve. The warming curve may be set in advance based on a production requirement.

The delivery rate of the glass raw material refers to a rate at which the glass raw material is delivered into the glass furnace. In some embodiments, the processor may determine a delivery rate at which the glass melt begins to warm in the glass furnace as the initial delivery rate. The delivery rate at different moments in the warming process may be set in advance based on production requirements.

The next triggering interval refers to a time interval between the current time point and the next time point. The current time point refers to a triggering time point at which the target parameter needs to be currently determined. The next time point refers to a triggering time point subsequent to the current time point. It will be understood that in the process of the platinum channel warming up to the preset temperature, whenever a time reaches one triggering time point, the processor may calculate the next triggering interval and further determine the next time point by taking the triggering time point as the current time point.

In some embodiments, the next triggering interval may be related to the current warming rate, the current delivery rate, and the target elicitation amount volume at the current time point. For example, the next triggering interval may be positively correlated with the current warming rate, and negatively correlated with the current delivery rate and the target elicitation amount. For example, the processor may determine the next triggering interval via the following equation (1):

$$I = q * T / N - p * E . \qquad ( 1 )$$

In equation (1), I denotes the next triggering interval, T denotes the current warming rate, N denotes the current delivery rate, E denotes the target elicitation amount, and q and p are preset weights. The preset weights may be set in advance based on historical experience.

In some embodiments, the processor may determine a time interval between a moment the warming begins and the initial time point based on the initial warming rate, the initial delivery rate, and the target elicitation amount through the above manner, thereby determining the initial time point.

In some embodiments, the processor may determine a time point that is subsequently separated from the current time point by the next triggering interval as the next time point.

In some embodiments of the present disclosure, the next triggering interval may be determined through the target elicitation amount, the warming rates at different moments, and the delivery rate of the glass raw material, and then the time point at which the target parameter of the driving device may be determined without the need for continuous computing in the process of the platinum channel warming up to the preset temperature, which saves labor and material resources.

The displacement information of the initial traction hook refers to information related to displacement of the initial traction hook. In some embodiments, the displacement information may include a displacement direction, a displacement distance, etc.

In some embodiments, the displacement direction may include an upward direction and a downward direction in a direction of gravity and a forward direction and a reverse direction in a direction of the flow of the glass melt, etc. The upward direction and the downward direction of the direction of gravity may correspond to a direction of deformation collapse of the cooling flat tube during warming.

The inflation information of the heater modules refers to information related to inflation of the heater modules. In some embodiments, the inflation information may include an inflation direction, an inflation size, etc. In some embodiments, the inflation direction may include a direction similar to a direction included in the displacement direction.

In some embodiments, the processor may obtain the displacement information and the inflation information via the displacement sensor. More descriptions regarding the displacement sensor may be found in FIG. 6 and the related descriptions thereof.

In some embodiments, the processor may determine, based on the displacement information of the initial traction hook, the inflation information of the heater modules, comprehensive force information of the initial traction hook through a preset algorithm, and determine, based on the comprehensive force information of the initial traction hook, the target parameter.

The comprehensive force information may be configured to reflect the comprehensive force of the initial traction hook after the displacement of the initial traction hook and the inflation of the heater modules work together. In some embodiments, the comprehensive force information may include a force direction, deformation displacement, etc. In some embodiments, the preset algorithm may include a virtual displacement manner, a stiffness matrix manner of finite element analysis, etc.

In some embodiments, the reinforcing hook may be driven in a direction opposite to the force direction, and the reinforcing hook may be driven by a same distance as the deformation displacement.

In some embodiments, in response to a determination that the target parameter is greater than a driving threshold, the processor may convert the target parameter to an own control parameter. The driving device may pull, based on the own control parameter, the reinforcing hook to move. The own control parameter refers to a control parameter of the driving device. For example, the own control parameter may include a motor speed, a cylinder stroke, etc. The processor may convert the target parameter into the own control parameter through proportional-integral-differential (PID) control, state-space control, etc. The driving threshold may be set in advance based on accuracy of the driving device or historical experience. For example, the driving threshold may need to be greater than a control accuracy of the driving device.

In some embodiments of the present disclosure, by analyzing and processing the real-time force information of the initial traction hook, the target parameter of the driving device may be determined to pull the reinforcing hook to move to tract the traction hanging bar, so that the traction may be performed when the degree of deformation of the cooling flat tube of the platinum channel during warming is relatively small to prevent collapsing earlier.

In some embodiments, before the traction hanging bar is welded, the processor may determine a mounting sequence of the traction structure based on the mounting information of a heater module connected to the traction structure, dimensional information of the cooling flat tube, and a target elicitation amount of the glass melt. More descriptions regarding the target elicitation amount may be found in the related descriptions thereof.

The mounting information of the heater module refers to information related to mounting of the heater module. In some embodiments, the mounting information may include a dimension, a count, etc. of the heater module mounting. The dimension of the heater module mounting may include a length of the heater module, etc.

The dimensional information of the cooling flat tube refers to information related to a dimension of the cooling flat tube. In some embodiments, the dimensional information may include a length, a width, a thickness, a rhodium content, etc. of the cooling flat tube.

In some embodiments, the processor may obtain the mounting information and the dimensional information through user input, etc. The mounting information and the dimensional information may be determined by a user based on production requirements (e.g., the target elicitation amount).

The mounting sequence of the traction structure refers to a sequence including mounting positions of the traction structure. In some embodiments, the mounting sequence of the traction structure may include a plurality of mounting positions, and a dimension and a rhodium content of the traction structure corresponding to each of the mounting positions. A count of mounting positions may be smaller than or equal to a count of docking seams.

In some embodiments, the processor may determine the mounting sequence of the traction structure in various ways. For example, the processor may construct a dimensional feature vector based on the mounting information, the dimensional information, and the target elicitation amount, match a reference dimensional vector that satisfies a matching condition through a vector database, and determine a label corresponding to the reference dimensional vector as the mounting sequence. The label may include the mounting sequence (i.e., the mounting positions of the traction structure) of the traction structure corresponding to the reference dimensional vector. The matching condition may include that a similarity of the dimensional feature vector and a reference dimensional vector is the highest. The vector similarity may be negatively correlated with a distance of the vectors. The distance of vectors may include an Euclidean distance, etc.

The vector database may be set in advance based on historical data and include a plurality of reference dimensional vectors and a label of each reference dimensional vector.

In some embodiments, the processor may obtain preferred historical data by filtering the historical data, and construct, based on the preferred historical data, the vector database. The processor may obtain the historical data through a storage. Data in the storage that is related to a single historical production process may be one piece of historical data.

The preferred historical data refers to the historical data configured to construct the vector database. In some embodiments, the preferred historical data refers to historical data of which a total score is greater than a scoring threshold. In some embodiments, the processor may extract a historical mounting sequence of a historical traction structure of the historical data, obtain a single score by scoring each historical mounting position of the historical mounting sequence, and take a sum of the plurality of single scores as a total score of the historical data corresponding to the historical mounting sequence. The scoring threshold may be determined based on the total score of the plurality of historical data. For example, the scoring threshold may be a median of the plurality of total scores sorted from large to small, etc.

In some embodiments, the processor may determine the single scores of the historical mounting positions based on historical dimensional information, a historical target elicitation amount, historical failure information, and a rhodium content of the historical traction structure corresponding to the historical mounting positions of the historical data corresponding to the historical mounting positions.

The failure information refers to information related to a thermocouple failure. In some embodiments, the failure information may include a failure position and a count of failures at the failure position.

The failure position refers to a position where a failed thermocouple is located. The count of failures refers to a count of failed thermocouples at the failure position. It is understood that there may be more than one thermocouple at a single failure position.

In some embodiments, the processor may be communicatively connected to the thermocouple. If the processor loses communication with the thermocouple, the thermocouple may be determined to be failed.

It is understood that the thermocouple fails due to a tensile force acting on thermo wires of the thermocouple. The greater the count of failed thermocouples is, the smaller the structural strength of the cooling flat tube may be.

In some embodiments, the single scores of the historical mounting positions may be correlated with the historical dimensional information, the historical target elicitation amount, and the rhodium content of the historical traction structure corresponding to the historical mounting positions. For example, the single scores may be positively correlated with the historical dimensional information and the historical target elicitation amount, and the single scores may be negatively correlated with the rhodium content of the historical traction structure. For example, the processor may determine the single score via the following equation (2):

$$S = - a * M + b * D + c * E - d . \qquad ( 2 )$$

In equation (2), S denotes the single score, M denotes the rhodium content of the historical traction structure, D denotes the historical dimensional information, E denotes the historical target elicitation amount, and a, b, and c are preset coefficients. A value of d is related to the historical failure information. If the thermocouple at the historical mounting position in the historical failure information fails, d is a positive value. If the thermocouple at the historical mounting position in the historical failure information does not fail, d is 0.

In some embodiments of the present disclosure, the mounting sequence of the traction structure with a better effect may be quickly determined based on the mounting information of the heater modules, the dimensional information of the cooling flat tube, and the target elicitation amount using the vector database, so as to make the mounting position of the traction structure more reasonable, which is conducive to preventing the cooling flat tube from collapsing.

In some embodiments, after the platinum channel warms up to the preset temperature, and the inflation of the platinum channel basically ends, the processor may determine a filling amount of the secondary filling based on a sequence of inflation information of the heater module connected to the traction structure.

The secondary filling refers to filling the docking seam after the gap between the cooling flat tube and the plurality of heater modules is filled. In some embodiments, the secondary filling may adopt any feasible powder, for example, an alumina fine powder with a particle size of 0.1 mm, etc.

The sequence of inflation information of the heater module refers to a sequence consisting of the plurality of triggering time points and the inflation information of the heater module at each of the triggering time points.

In some embodiments, the processor may extract, based on the sequence of inflation information, inflation information of a preset count of times in the sequence of inflation information, obtain a comprehensive inflation dimension by performing weighted summation on inflation dimensions in the extracted plurality pieces of inflation information, and determine, based on the comprehensive inflation dimension, the filling amount of the secondary filling. The preset count of times may be set in advance based on historical experience. For example, the preset count of times may be N (e.g., ten, etc.) pieces of inflation information that are closest to the current time. The weight of each inflation information may be determined based on an order of the inflation information in the sequence of inflation information. The further back the inflation information is in the sequence of inflation information, the greater the weight may be. A large weight of the inflation information close to the current time may reduce the bias of a single piece of inflation information, thereby determining a more accurate filling amount.

In some embodiments, the processor may determine the filling amount of the secondary filling in various ways based on the comprehensive inflation dimension. For example, the processor may determine the filling amount of the secondary filling by querying a preset comparison table based on the comprehensive inflation dimension. The preset comparison table may be set in advance based on historical experience, and may include a correspondence between the comprehensive inflation dimension and the filling amount of the secondary filling. As another example, the processor may determine the filling amount of the secondary filling based on the comprehensive inflation dimension through a filling amount algorithm. The filling amount algorithm may include any feasible algorithm that can calculate the filling amount based on a dimension of the docking seam, a compactness requirement, etc.

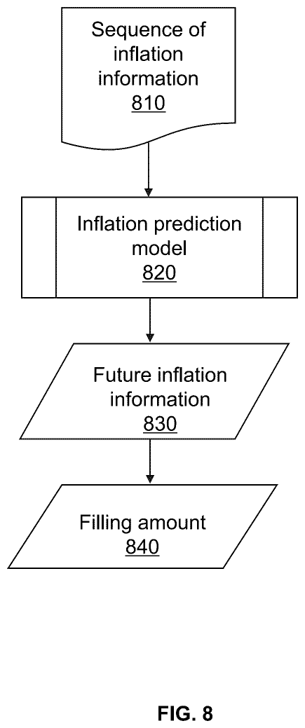

In some embodiments, the processor may also determine, based on the sequence of inflation information, future inflation information via an inflation prediction model, and determine the filling amount of the secondary filling based on the future inflation information. More descriptions regrading for the part may be found in FIG. 8 and its related descriptions thereof.

In some embodiments of the present disclosure, if a sealing degree of the docking seam is relatively poor, the platinum channel may fracture as the temperature rises. The comprehensive inflation dimension may be obtained by performing the weighted summation on the inflation dimensions of the heater modules, which reduces the bias of the single piece of inflation information, thereby determining a more accurate filling amount and avoiding poor sealing or even fracture of the platinum channel due to insufficient filling amount.

FIG. 8 is a schematic diagram illustrating an exemplary inflation prediction model according to some embodiments of the present disclosure.

In some embodiments, the processor may determine, based on a sequence of inflation information 810, future inflation information 830 through an inflation prediction model 820, and determine a filling amount 840 of secondary filling based on the future inflation information 830.

More descriptions regarding the sequence of inflation information may be found in FIG. 7 and its related descriptions thereof.

The future inflation information refers to a sequence of inflation information of the heater modules at a future time point. The future time point may be set in advance based on historical experience.

In some embodiments, the inflation prediction model refers to a model configured to predict the future inflation information. In some embodiments, the inflation prediction model may include a machine learning model, for example, a recurrent neural network (RNN) model, other customized model structures, or the like, or any combination thereof.

In some embodiments, the inflation prediction model may be obtained by training a large number of first training samples with first labels via a gradient descent manner, etc. The first training samples may include a sequence of sample inflation information obtained at a first time, and the first labels may include actual inflation information at a second time corresponding to the first training samples. The second time may be later than the first time.

In some embodiments, the first training samples and the first labels may be obtained based on historical data. For example, the processor may determine a sequence of historical inflation information at a historical first time of the historical data as the first training samples, and a sequence consisting of inflation information corresponding to a historical second time after the platinum channel warms up to a preset temperature as the first labels.

In some embodiments, the processor may input the plurality of first training samples with the first labels into an initial inflation prediction model, construct a loss function based on the labels and an output of the initial inflation prediction model, and iteratively update, based on the loss function, a parameter of the initial inflation prediction model through gradient descent or other manners. The model training may be completed when a preset condition is met, and a trained inflation prediction model may be obtained. The preset condition may include the loss function converging, a count of iterations reaching a threshold, etc.

In some embodiments, the processor may determine, based on the future inflation information, a future comprehensive inflation dimension corresponding to the future inflation information, and determine, based on the future comprehensive inflation dimension, the filling amount of the secondary filling. The future comprehensive inflation dimension may be determined in a manner similar to a manner for determining the comprehensive inflation dimension. The filling amount of the secondary filling may be determined based on the future comprehensive inflation dimension in a manner similar to the manner for determining the filling amount of the secondary filling based on the comprehensive inflation dimension. More descriptions regarding the determining the comprehensive inflation dimension and the determining the filling amount of the secondary filling based on the comprehensive inflation dimension may be found in FIG. 7 and the related descriptions thereof.

In some embodiments of the present disclosure, the future inflation information may be quickly and accurately predicted using the inflation prediction model, and the inflation that is likely to occur in the heater modules at a future time may be obtained, so that the filling amount that is compatible with the inflation that is likely occur in the heater modules in the secondary filling may be determined, thereby further preventing poor sealing of the docking seam due to insufficient filling.

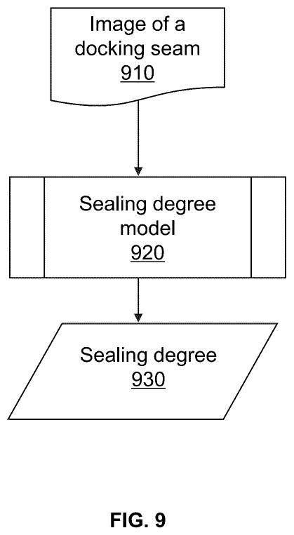

FIG. 9 is a schematic diagram illustrating an exemplary sealing degree model according to some embodiments of the present disclosure.

In some embodiments, a processor may determine a predicted sealing degree 930 based on an image of a docking seam 910 during the secondary filling through a sealing degree model 920. In response to a determination that the predicted sealing degree satisfies a sealing condition, and an actual filling amount of the secondary filling satisfies the filling condition, the secondary filling may be stopped. An image obtaining device may continuously obtain the image of the docking seam during the secondary filling and upload the image of the docking seam to the processor. The processor may update a predicted sealing degree in real time based on the real-time obtained image of the docking seam.

More descriptions regarding the image of the docking seam and the obtaining the image of the docking seam may be found in FIG. 6 and the related descriptions thereof.

The predicted sealing degree refers to a predicted degree of sealing of the docking seam. The predicted sealing degree may be expressed by a numerical value, etc. The larger the value is, the greater the predicted sealing degree may be.

In some embodiments, the sealing degree model may be a model configured to determine the predicted sealing degree. In some embodiments, the sealing degree model may include a machine learning model, for example, a convolutional neural networks (CNNs) model, other customized model structures, or the like, or any combination thereof.

In some embodiments, the sealing degree model may be obtained by training a large number of second training samples with second labels via a gradient descent manner, etc. The second training samples may include sample images of the docking seam, and the labels may be actual sealing degrees corresponding to the second training samples.

In some embodiments, the second training samples and the second labels may be obtained based on experiments. For example, the experiment samples may include at least two heater module samples and platinum channel samples. A plurality of rounds of experiments may be performed through the experiment samples. Each round of experiments may include a secondary filling of the docking seam of the two heater module samples. During each round of experiments, the experiment samples may be heated, the images of the docking seam may be obtained as the second training samples from the start of the experiment to the cracking of the docking seam, and an duration of the experiment from the start of the experiment to the cracking of the docking seam may be obtained. Actual sealing degrees of the experiment samples may be determined based on the duration of the experiment, and the actual sealing degrees may be used as the second labels. The larger the duration of the experiment is, the larger the actual sealing degrees may be. The filling amounts of the secondary filling may be different for each round of the plurality of rounds of experiments. The experimental samples may be built in advance based on actual production needs.

In some embodiments, the sealing degree model may be trained in a manner similar to a manner for training the inflation prediction model. More descriptions regarding the manner for training the inflation prediction model may be found in FIG. 8 and the related descriptions thereof.

In some embodiments, in response to a determination that the predicted sealing degree satisfies the sealing condition, and the actual filling amount of the secondary filling satisfies the filling condition, the processor may determine to stop the secondary filling. The actual filling amount may be determined by user input, etc.

In some embodiments, the sealing condition may include that the predicted sealing degree is greater than a sealing degree threshold. The filling condition may include that the actual filling amount is greater than the determined filling amount. The determined filling amount refers to a filling amount determined by a manner for determining the filling amount in any of the embodiments. The sealing degree threshold may be set in advance based on historical experience. The actual filling amount may be greater than the determined filling amount, which prevents an insufficient filling amount due to volatilization.

In some embodiments of the present disclosure, the sealing degree of the docking seam may be efficiently predicted using the sealing degree model, thereby accurately determining whether to stop the secondary filling and reducing the cost of powder.

Some embodiments of the present disclosure provide a device for preventing a cooling flat tube of a platinum channel from collapsing during warming. The device may include a traction structure. The cooling flat tube (1) may be externally wrapped with a plurality of heater modules (4). A docking seam may be disposed between every two docked heater modules (4). The traction structure may be disposed on an outer surface of the cooling flat tube (1). The traction structure may include a traction hanging bar (3). A position of the traction hanging bar (3) may coincide with a position of the docking seam. A protruding end of the traction hanging bar (3) may extend out of the docking seam. The protruding end may be connected to an end of one of the two docked heater modules (4), and a height of the traction hanging bar (3) may be equal to a height of a gap between the cooling flat tube (1) and the plurality of heater modules (4).

In some embodiments, the traction structure may further include a traction substrate (2). The traction substrate (2) may be connected to an upper surface of the cooling flat tube (1).

In some embodiments, the traction substrate (2) may adopt a variable wall thickness structure. The variable wall thickness structure may include that a wall thickness of the traction substrate changes from small to large and then from large to small in a radial direction of the cooling flat tube.

In some embodiments, the traction substrate (2) may include a rectangular platinum sheet, and the rectangular platinum sheet may be connected to the rectangular platinum sheet through a hot forging patch.

In some embodiments, the traction hanging bar (3) may include the welding bottom (3-1), the extension arm (3-2), and the traction hook (3-3). The welding bottom (3-1) may be welded to the traction substrate (2). The extension arm (3-2) may be disposed in the docking seam. An upper surface of the end of the two docked heater modules (4) may be provided with a transverse through groove structure (4-1), and the traction hook (3-3) may be suspended in the transverse through groove structure (4-1).

In some embodiments, a width of the docking seam may be greater than 20% of a width of the extension arm (3-2), and a depth of the transverse through groove structure (4-1) may be in a range of 5 mm-10 mm.

In some embodiments, a radial dimension distribution of the traction hanging bar (3) may be the same as a radial dimension distribution of a cross section of the cooling flat tube (1).

In some embodiments, a material of the traction hanging bar (3) may include a platinum-rhodium alloy material, and a rhodium content of the platinum-rhodium alloy material may be in a range of 10%-20%.

In some embodiments, a filler layer (5) may be disposed between the cooling flat tube (1) and the plurality of heater modules (4).

Some embodiments of the present disclosure provide a method for preventing a cooling flat tube of a platinum channel from collapsing during warming. The method may be implemented by a device for preventing a cooling flat tube of a platinum channel from collapsing during warming in any one of the embodiments. The method may include: assembling a section of heater modules (4); filling the cooling flat tube (1) with powder, wherein in the filling process, the cooling flat tube (1) is vibrated using a vibrator with an amplitude of the vibration being smaller than 2 mm, and the vibration of the cooling flat tube is stopped when the filling is finished; starting to heat the platinum channel; and after the platinum channel warms up to 1300° C., filling the docking seam of which the traction hanging bar (3) extending out using alumina fine powder with a particle size of 0.1 mm.

In addition, certain features, structures, or characteristics of one or more embodiments of the present disclosure may be suitably combined.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

By way of example, should there be any inconsistency or conflict between the description, definition, and/or the use of a term associated with any of the incorporated material and that associated with the present document, the description, definition, and/or the use of the term in the present document shall prevail.

What is claimed is:

1. A device for preventing a cooling flat tube of a platinum channel from collapsing during warming, comprising a traction structure, wherein
a cooling flat tube is externally wrapped with a plurality of heater modules,
there is a gap between the cooling flat tube and the plurality of heater modules,
a docking seam is disposed between every two docked heater modules,
the traction structure is disposed on an outer surface of the cooling flat tube,
the traction structure includes a traction hanging bar, a position of the traction hanging bar coincides with a position of the docking seam, a protruding end of the traction hanging bar extends out of the docking seam,
the protruding end is connected to an end of one of the two docked heater modules, and a height of the traction hanging bar is equal to a height of the gap between the cooling flat tube and the plurality of heater modules.

2. The device of claim 1, wherein the traction structure further includes a traction substrate, the traction substrate being connected to an upper surface of the cooling flat tube.

3. The device of claim 2, wherein the traction substrate adopts a variable wall thickness structure, the variable wall thickness structure including that a wall thickness of the traction substrate changes from small to large and then from large to small in a radial direction of the cooling flat tube.

4. The device of claim 2, wherein the traction substrate includes a rectangular platinum sheet, and the rectangular platinum sheet is connected to the upper surface of the cooling flat tube through a hot forging patch.

5. The device of claim 2, wherein the traction hanging bar includes a welding bottom, an extension arm, and a traction hook, the welding bottom being welded to the traction substrate, the extension arm being disposed in the docking seam, an upper surface of the end of the one of the two docked heater modules being provided with a transverse through groove structure, and the traction hook being suspended in the transverse through groove structure.

6. The device of claim 5, wherein a width of the docking seam is greater than 20% of a wall thickness of the extension arm, and a depth of the transverse through groove structure is in a range of 5 mm to 10 mm.

7. The device of claim 5, further comprising a reinforcing hook, wherein the traction hanging bar includes an initial traction hook, a gap between the reinforcing hook and the initial traction hook is smaller than a gap between the traction hook and the transverse through groove structure, and the reinforcing hook is provided with a driving device.

8. The device of claim 7, further comprising a plurality of displacement sensors, wherein the plurality of displacement sensors being disposed at the initial traction hook and/or the plurality of heater modules, and the plurality of displacement sensors are configured to measure displacement information of the initial traction hook and/or inflation information of the plurality of heater modules.

9. The device of claim 8, further comprising a processor, the processor being communicatively connected to the driving device disposed at the reinforcing hook and the plurality of displacement sensors.

10. The device of claim 1, wherein a radial dimension distribution of the traction hanging bar is the same as a radial dimension distribution of a cross section of the cooling flat tube.

11. The device of claim 1, wherein a material of the traction hanging bar includes a platinum-rhodium alloy material, and a rhodium content of the platinum-rhodium alloy material is in a range of 10%-20%.

12. The device of claim 1, wherein a filler layer is disposed between the cooling flat tube and the plurality of heater modules.

13. The device of claim 1, further comprising an image obtaining device configured to obtain an image of the docking seam.

14. A method for preventing a cooling flat tube of a platinum channel from collapsing during warming, implemented by a device including a traction structure, wherein
a cooling flat tube is externally wrapped with a plurality of heater modules,
there is a gap between the cooling flat tube and the plurality of heater modules,
a docking seam is disposed between every two docked heater modules,
the traction structure is disposed on an outer surface of the cooling flat tube,
the traction structure includes a traction hanging bar, a position of the traction hanging bar coincides with a position of the docking seam, a protruding end of the traction hanging bar extends out of the docking seam,
the protruding end is connected to an end of one of the two docked heater modules, and a height of the traction hanging bar is equal to a height of the gap between the cooling flat tube and the plurality of heater modules; and
the method comprises:
assembling the plurality of heater modules;
filling the cooling flat tube with powder, wherein in the filling process, the cooling flat tube is vibrated, and the vibration of the cooling flat tube is stopped when the filling is finished;
starting to heat the platinum channel; and
after the platinum channel warms up to a preset temperature, performing a secondary filling on the docking seam where the traction hanging bar protrudes.

15. The method of claim 14, wherein the method is executed by a processor, and the method further includes:
determining a plurality of triggering time points in the process of the platinum channel warming up to the preset temperature; and
at each of the plurality of triggering time points, determining, based on displacement information of an initial traction hook and inflation information of a heater module connected to the traction structure, a target parameter of a driving device to cause the driving device to pull, based on the target parameter, a reinforcing hook to move.

16. The method of claim 15, wherein the determining a plurality of triggering time points in the process of the platinum channel warming up to the preset temperature includes:
determining an initial time point based on an initial warming rate, an initial delivery rate of glass raw material, and a target elicitation amount of glass melt; and
at the initial time point and at each subsequent time point,
determining a next triggering interval based on a current warming rate, a current delivery rate, and the target elicitation amount; and
determining a next time point based on a current time point and the next triggering interval.

17. The method of claim 14, further comprising:
determining a mounting sequence of the traction structure based on mounting information of a heater module connected to the traction structure, dimensional information of the cooling flat tube, and a target elicitation amount of glass melt.

18. The method of claim 14, further comprising:
determining a filling amount of the secondary filling based on a sequence of inflation information of a heater module connected to the traction structure.

19. The method of claim 18, wherein the determining a filling amount of the secondary filling based on a sequence of inflation information of a heater module connected to the traction structure includes:
determining, based on the sequence of inflation information, future inflation information through an inflation prediction model, the inflation prediction model being a machine learning model; and
determining the filling amount of the secondary filling based on the future inflation information.

20. The method of claim 18, further comprising:
determining a predicted sealing degree based on an image of the docking seam during the secondary filling through a sealing degree model, the sealing degree model being a machine learning model; and
in response to a determination that the predicted sealing degree satisfies a sealing condition, and an actual filling amount of the secondary filling satisfies a filling condition, stopping the secondary filling.
